(19) United States
(12) Patent Application Publication
(10) Pub. No.: US 2013/0004169 A1
(43) Pub. Date: Jan. 3, 2013

(54) EFFICIENT METHOD TO EXTRACT A LOWER ORDER (LO) OPTICAL CHANNEL DATA UNIT (ODU)j SIGNAL FROM HIGHER ORDER (HO) OPTICAL CHANNEL TRANSPORT UNIT (OTU)k SIGNAL

(75) Inventors: MOHAMAD SAMI MOHAMAD, Nepean (CA); HAO LU, Ottawa (CA)

(73) Assignee: EXAR CORPORATION, Fremont, CA (US)

(21) Appl. No.: 13/173,556

(22) Filed: Jun. 30, 2011

(51) Int. Cl. H04J 14/00

(52) U.S. Cl. 398/45

(57) ABSTRACT

A Higher order (HO) Optical channel Data Unit (ODU)k signal is extracted from an HO Optical channel Transport Unit (OTU)k signal using a first clock at or faster than the OTUk clock. An HO Optical channel Payload Unit OPUk signal is extracted from the HO ODUk signal using the first clock. An Optical channel Data Tributary Unit (ODTU) signal is demultiplexed from the HO OPUk signal using the first clock. The ODTU signal is demapped to a lower order (LO) ODUj signal. The LO ODUj data is then smoothed using a smoothing function. Only one clock is used for the multiple stages of extraction of a LO ODUj from a HO OTUk signal.

### FIELD OF THE INVENTION

The present invention relates ways of extracting a Lower order (LO) Optical channel Data Unit (ODU)j signal from a Higher order (HO) Optical channel Transport Unit (OTU)k signal.

### BACKGROUND

The Optical Transport Network (OTN) is a set of Optical Network Elements connected by optical fiber links, able to provide functionality of transport, multiplexing, switching, management, supervision and survivability of optical channels carrying client signals.

ITU-T G.709/Y.1331 describes interfaces for the Optical Transport Network (OTN).

The following Optical channel Transport Unit (OTU) signals are described in ITU-T G.709/Y.1331 (12/2009):
* OTU1, which can transport a constant bit rate client signal with bit rate close to 2.5 Gbit/s (such as: STM-16 signal), has a bit rate of 255/238×2488320 kbit/s±20 ppm.
* OTU2, which can transport a constant bit rate client signal with bit rate close to 10 Gbit/s (such as: STM-64 signal), has a bit rate of 255/237×9953280 kbit/s±20 ppm.
* OTU3, which can transport a constant bit rate client signal with bit rate around 40 Gbit/s (such as: STM-256 signal, 40 Gigabit Ethernet signal), has a bit rate of 255/236×39813120 kbit/s±20 ppm.
* OTU4, which can transport a constant bit rate client signal with bit rate around 100 Gbit/s (such as: 100 Gigabit Ethernet signal), has a bit rate of 255/227×99532800 kbit/s±20 ppm.

The OTU is an information structure into which ODU (Optical channel Data Unit) is mapped. ODU is an information structure into which OPU (Optical channel Payload Unit) is mapped. OPU is an information structure into which a client signal can be mapped or LO (Lower Order) ODUj signals can be time-division multiplexed. The following configurations of LO ODUj time-division multiplexing into HO (Higher Order) OPUk are described in ITU-T G.709 (2009/12):
Up to 2 ODU0 signals can be multiplexed into an OPU1 (PT=20).
Up to 4 ODU1 signals can be multiplexed into an OPU2 (PT=20).
A mixture of up to 4 ODU2 and up to 16 ODU1 signals can be multiplexed into an OPU3 (PT=20).
A mixture of up to 8 ODU0, up to 4 ODU1, and up to 8 ODUflex signals can be multiplexed into OPU2 (PT=21).
A mixture of up to 32 ODU0, up to 16 ODU1, up to 4 ODU2, up to 3 ODU2e and up to 32 ODUflex signals can be multiplexed into an OPU3 (PT=21).
A mixture of up to 80 ODU0, up to 40 ODU1, up to 10 ODU2, up to 10 ODU2e, up to 2 ODU3 and up to 80 ODUflex signals can be multiplexed into an OPU4 (PT=21).

When extracting a LO ODUj from a HO OTUk, the following actions are done: 1) Extracting HO ODUk from HO OTUk; 2) Extracting HO OPUk from HO ODUk; 3) Demultiplexing ODTU from HO OPUk; 4) Demapping ODTU to the LO ODUj. An example of extracting ODU0/ODUflex/ODU1 from OTU2 is shown in FIG. 1.

As shown in FIG. 2, an OTU frame is constructed in a 4-row and 4080 column octet based block structure. Due to the fact that the LO ODUj are demultiplexed out of HO OPUk payload area and there are 16 bytes (OTU/ODU/OPU OH) and 256 bytes FEC between two adjacent row of OPUk payload, directly extracting LO ODUj out of HO OPUk leads to burstiness in the LO ODUj data.

If the HO ODUk is terminated at a smoothed ODUk clock that is generated from HO OTUk clock * 239/255 and HO OPUk is terminated at a smoothed OPUk clock that is generated from a HO ODUk clock * 238/239, then most of the possible burstiness in the LO ODUj demultiplexed from HO OPUk is removed.

FIG. 3 shows an exemplary prior art extraction of a LO ODUj signal from a HO OTUk signal. Only one extracted LO ODUj signal is shown for simplicity, but typically multiple LO ODUj signals are created. As shown in FIG. 3, multiple different clocks are used for the steps of the extraction.

### SUMMARY

Embodiments of the present invention use a single clock (the OTUk clock or a clock that runs faster than the OTUk clock) for multiple stages of the extraction rather than making different clocks for the different stages. At the final stage, the data can be smoothed with a smoothing function. This smoothing function supports the extraction of any LO ODUj (j can be flex, 0, 1, etc.) from a HO OTUk signal.

In one embodiment, a Higher order (HO) Optical channel Data Unit (ODU)k signal is extracted from an HO Optical channel Transport Unit (OTU)k signal using the OTUk clock or a clock which runs faster than the OTUk clock. An HO Optical channel Payload Unit OPUk signal is extracted from the HO ODUk signal using the OTUk clock or the clock (which runs faster than the OTUk clock). An Optical channel Data Tributary Unit (ODTU) signal is demultiplexed from the HO OPUk signal using the OTUk clock or the clock (which runs faster than the OTUk clock). The ODTU signal is demapped to a lower order (LO) ODUj signal using the OTUk clock or the clock (which runs faster than the OTUk clock). The LO ODUj data is smoothed using a smoothing function.

### BRIEF DESCRIPTION OF THE DRAWINGS

FIG. 1 shows a diagram of the extraction of LO ODUj from HO OTUk.

FIG. 2 shows an exemplary OTU frame.

FIG. 3 shows an exemplary prior art extraction of a LO ODUj signal from a HO OTUk signal.

FIG. 4 shows an exemplary extraction of an ODUj signal from a OTUk signal of the present invention where intermediate stages use the use a single clock (the OTUk clock or a clock that runs faster than OTUk clock) and a smoothing function is used.

FIG. 5 shows an exemplary ODUj smoother of one embodiment.

FIG. 6 shows an exemplary smoothing method using a sigma delta algorithm.

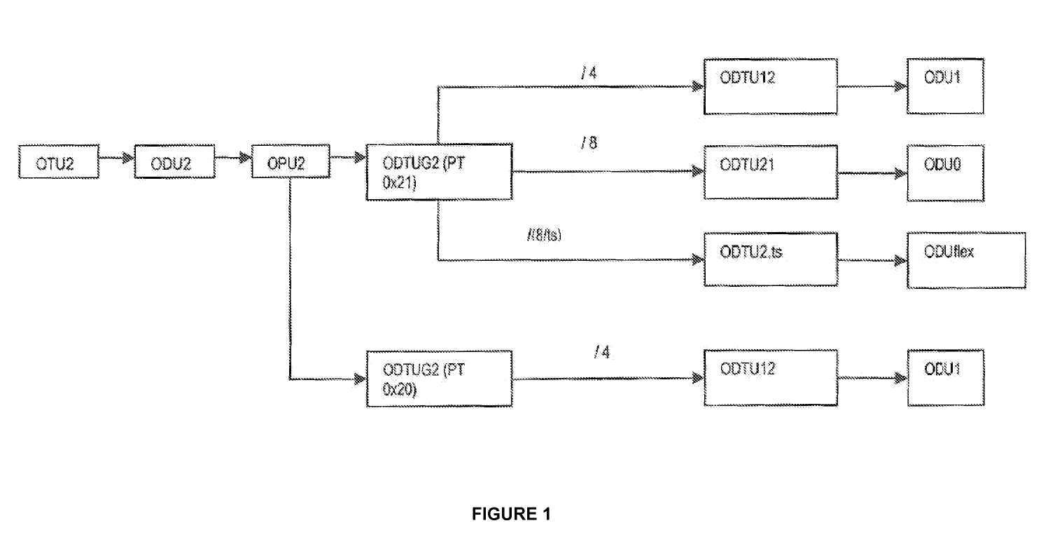

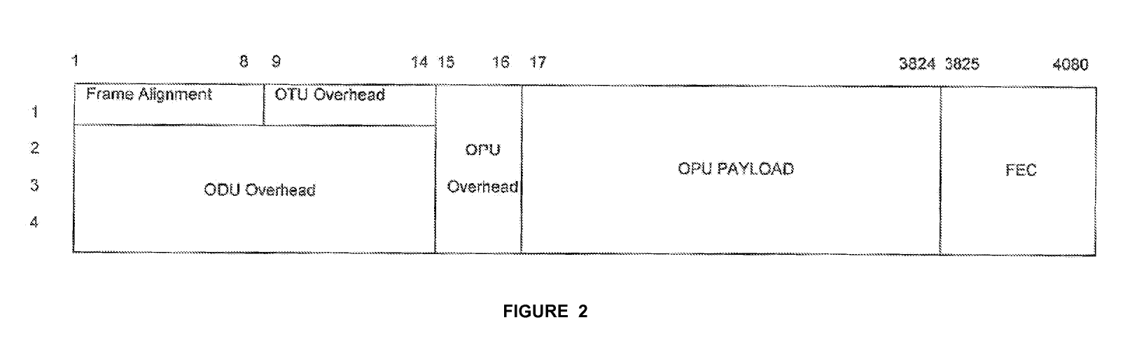

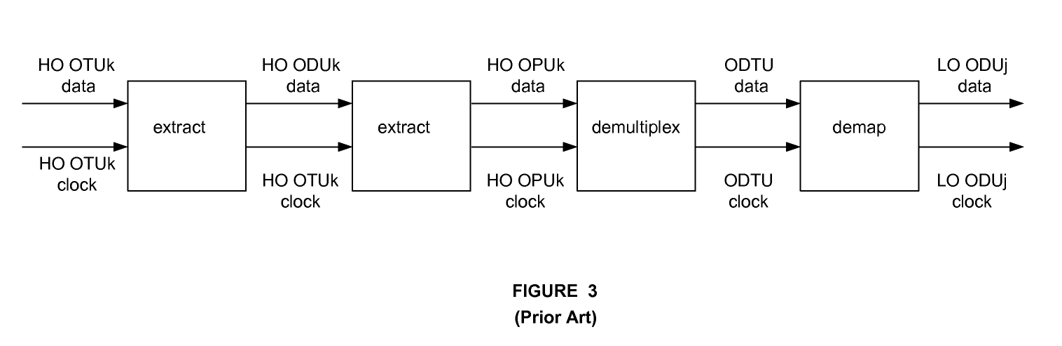

### DETAILED DESCRIPTION

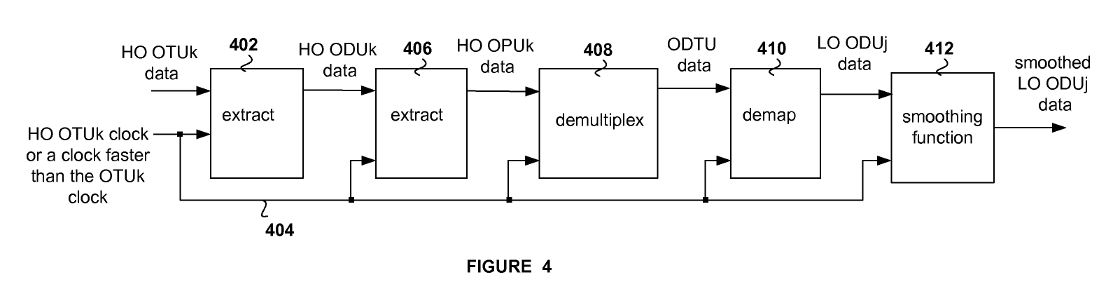

FIG. 4 shows an extraction of LO ODUj signal from a HO OTUk signal. The block uses a single clock (the OTUk clock or a clock that runs faster than OTUk clock), rather than deriving new clocks for each stage. This means that the data output ODUj will be jittery. The jittery ODUj output is smoothed in the smoothing block 412.

In one embodiment, the OTUk clock is used throughout the extraction process. Alternately, a single clock that runs faster than the OTUk clock can be used throughout the extraction process. In both cases, the ODUj output is smoothed in the smoothing process.

In this example, a Higher order (HO) Optical channel Data Unit (ODU)k signal is extracted from an HO Optical channel Transport Unit (OTU)k signal in block 404 using the OTUk clock or a clock which runs faster than the OTUk clock. An HO Optical channel Payload Unit OPUk signal is extracted from the HO ODUk signal in block 406 using the OTUk clock or the clock (which runs faster than the OTUk clock) on line 404. An Optical Channel Data Tributary Unit (ODTU) signal is demultiplexed from the HO OPUk signal in block 408 using the OTUk clock or the clock (which runs faster than the OTUk clock) on line 404. The LO ODUj data is smoothed using a smoothing function in block 412.

The smoothing function, in block 412, can use the OTUk clock or a clock (which runs faster than the OTUk clock) on line 404 to increment a round-robin counter with a value between 1 and an integer P.

When Cm is the number of LO ODUj n-byte data entities per HO OTUk multi-frame, n is the number of bytes per LO ODUj n-byte data entity, P is the number of bytes per HO OTUk multi-frame, and J is the round-robin counter incremented from 1 to P by the OTUk clock or a clock that runs faster than OTUk clock, the smoothing function can be defined to be the expression, (J*Cm*n) mod P<Cm*n, such that the smoothed data is valid if and only if the expression is true. After demultiplexing, the smoothed LO ODUj data is gated by the data valid signal which is decided by the above function.

The smoothing function can be implemented using an accumulated value that is compared to P. The accumulated value can be incremented in steps Cm*n until it becomes greater than P at which point the accumulated value is subtracted by P. This will implement the function (J*Cm*n) mod P.

For a Generic Mapping Procedure (GMP) LO ODUj, demultiplexing from HO OPUk, the Cm value, which represents the number of LO ODUj n-byte data entities for the next HO OTUk multi-frame, can be derived from the JC bytes in the HO OPUk Overhead.

For an Asynchronous Mapping Procedure (AMP) LO ODUj demultiplexing from HO OPUk, the Cm is calculated based on the nominal LO ODUj byte count inside per HO OTUk multi-frame plus the number of negative justifications or minus the number of positive justifications

Instead of requiring multiple clock sources at different layers, the method presented here uses only one clock source, i.e., not only HO OTUk, but also HO ODUk, and OPUk are terminated with the HO OTUk clock or a clock which runs faster than the OTUk clock. In this case, the extracted LO ODUj data is busty and a smoothing process can be applied to smooth the extracted LO ODUj data.

There are many ways to smooth the LO ODUj data that are extracted from HO OTUk. For example, when ODU1 demultiplexing from OPU2 out of OTU2, its nominal bit rate (without any positive or negative justification) is OTU2 bit rate*238/255*1/4. An easy way is to generate a clock gating signal with frequency equal to ¼ of OTU2 CLK. Then, within per OTU2 multi-frame, the following number of pulses from the derived gating signal will be removed: (1) 16 if there is one negative justification on that ODTU12; (2) 17 if there are not any justification on the ODTU12; (3) 18 if there is one positive justification on the ODTU12; (4) 19 if there is two positive justifications on the ODTU12. But, in the case of demultiplexing ODUflex from OPU2 out of OTU2, a simple algorithm as mentioned above does not work well. ODUflex is GMP mapped to a group of OPU2 1.25G slots. The number of OPU2 1.25G slots assigned to the group and the number of the group may carry ODUflex data vary and depend on the rate of the client signal that is Bitsynchronous Mapping Procedure (BMP) mapped to the OPUflex.

The smoothing function presented here is a generic algorithm that can be applied to smooth any LO ODUj data that are extracted from a HO OTUk signal regardless of whether the LO ODUj is GMP or AMP multiplexed into HO OPUk.

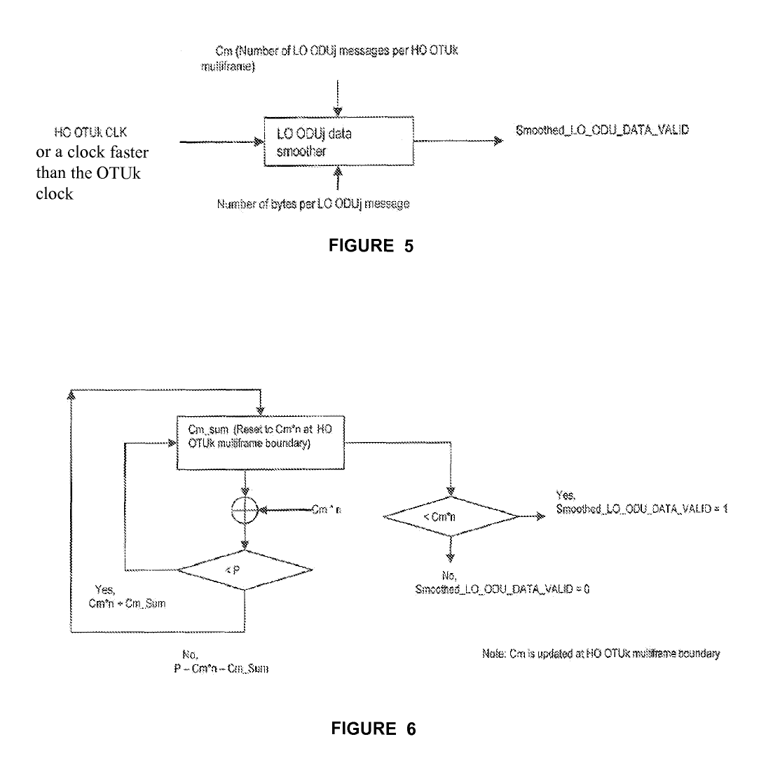

Based on the number of LO ODUj bytes per HO OTUk multi-frame and the total number of bytes per HO OTUk multi-frame, we can apply the principles of GMP using Sigma-Delta based method to decide the distribution of the smoothed LO ODUj data (or the smoothed_LO_ODU_DATA_VALID). FIG. 5 shows a block diagram.

One exemplary algorithm is discussed below. (See Table 1 for possible inputs—Cm, n, P when extracting ODU0, ODUflex, ODU1 from OTU2; Table 2 for possible inputs—Cm, n, P when extracting ODU0 from OTU1).

Cm=Number of LO ODUj n-byte data entities per HO OTUk multi-frame

n=the number of bytes per LO ODUj n-byte data entity

P=the number of bytes per HO OTUk multi-frame

J=a round-robin counter (at HO OTUk clk or a clock that runs faster that OTUk clk) from 1 to P

If (J*Cm*n) mod P<Cm*n Smoothed_LO_ODU_DATA_VALID=1, else Smoothed_LO_ODU_DATA_VALID=0.

FIG. 6 shows one of the implementations of the algorithm.

For the case of LO ODUj GMP demultiplexed from HO OPUk (such as: ODUflex or ODU0 demultiplexed from OPU2), according to ITU-T G.709 the Cm value derived from JC bytes of current HO OTUk multi-frame is the Cm for the next multi-frame. And it will be loaded to generate Smoothed_LO_ODU_DATA_VALID in the next OTUk multi-frame.

For the case of LO ODUj AMP demultiplexed from HO OPUk (such as: ODU1 demultiplexed from OPU2), the Cm can be calculated based on the nominal LO ODUj byte count insider per HO OTUk multi-frame plus the number of negative justifications or minus the number of positive justifications. This calculated Cm represents LO ODUj byte count for current HO OTUk multi-frame. Because Cm is only updated at HO OTUk multi-frame boundary, it will be loaded to at beginning of the next HO OTUk multi-frame to generate Smoothed_LO_ODU_DATA_VALID.

TABLE 1
Smoother inputs (Cm, n, P) when extracting LO ODUj (j = 0, 1, flex) from OTU2

| | | Cm (number of LO ODUj | |
|---|---|---|---|
| TYPE of | n: (number of byte per LO | n-byte data entities per | P (number of byte per |
| LO ODUj | ODUj n-byte data entity) | OTU2 multi-frame) | OTU2 multi-frame) |
| ODU1 | 1 | Min: 15230 (with 2 | 16320*4 |
| | | positive byte justifications) | |
| | | Nominal: 15232 | |
| | | (No justification) | |
| | | Max: 15233 (with 1 | |
| | | negative byte justification) | |
| ODU0 | 1 | Min: 15167 | 16320*8 |
| | | Nominal: 15168 | |
| | | Max: 15169 | |
| ODUflex | Variable: Depended on the | Variable: Depended on the | 16320*8 |
| | bit rate of client signal | bit rate of client signal | |
| | which is mapped into OPUflex | which is mapped into OPUflex | |

TABLE 2
Smoother inputs (Cm, n, P) when extracting ODU0 from OTU1

| | | Cm (number of LO ODUj | |
|---|---|---|---|
| TYPE of | n: (number of byte per LO | n-byte data entities per | P (number of byte per |
| LO ODUj | ODUj n-byte data entity) | OTU2 multi-frame) | OTU1 multi-frame) |
| ODU0 | 1 | Min: 15231 (with 1 | 16320*2 |
| | | byte positive justifications) | |
| | | Nominal: 15232 | |
| | | (no justifications) | |
| | | Max: 15233 (with 1 | |
| | | negative byte justification) | |

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A method comprising:
extracting a Higher order (HO) Optical channel Data Unit (ODU)k signal from an HO Optical channel Transport Unit (OTU)k signal using a first clock;
extracting an HO Optical channel Payload Unit OPUk signal from the HO ODUk signal using the first clock;
demultiplexing an Optical channel Data Tributary Unit (ODTU) signal from the HO OPUk signal using the first clock;
demapping the ODTU signal to a lower order (LO) ODUj signal, wherein the LO ODUj data is smoothed using a smoothing function, wherein the first clock runs at or faster than an OTUk clock.

2. The method of claim 1, wherein the first clock is the OTUk clock.

3. The method of claim 1, wherein the first clock is a clock that runs faster than the OTUk clock.

4. The method of claim 1, wherein the smoothing function uses the first clock to increment a round-robin counter with a value between 1 and an integer P.

5. The method of claim 4, wherein P is the number of bytes per HO OTUk multi-frame.

6. The method of claim 1, wherein when
Cm is the number of LO ODUj n-byte data entities per HO OTUk multi-frame;
n is the number of bytes per LO ODUj n-byte data entity;
P is the number of bytes per HO OTUk multi-frame; and
J is a round-robin counter incremented from 1 to P at the first clock;
the smoothing function is defined by the expression “(J*Cm*n)mod P<Cm*n”, such that the smoothed data is valid if and only if the expression is true.

7. The method of claim 6, wherein the smoothing function is implemented using an accumulated value that is compared to P.

8. The method of claim 7, wherein the smoothing function is implemented using the accumulated value which is incremented in steps of Cm*n until it becomes greater than P at which point the accumulated value is subtracted by P.

9. The method of claim 6, wherein for a Generic Mapping Procedure (GMP) LO UDUj, demultiplexing from HO OPUk, the Cm value, which represents the number of LO ODUj n-byte data entities for the next HO OTUk multi-frame, can be derived from the JC bytes in the HO OPUk Overhead.

10. The method of claim 6, wherein for an Asynchronous Mapping Procedure (AMP) LO ODUj demultiplexing from HO OPUk, the Cm is calculated based on the nominal LO ODUj byte count inside per HO OTUk multi-frame plus the number of negative justifications or minus then number of positive justifications.

11. A device adapted to:
extract a Higher order (HO) Optical channel Data Unit (ODU)k signal from an HO Optical channel Transport Unit (OTU)k signal using a first clock;
extract an HO Optical channel Payload Unit OPUk signal from the HO ODUk signal using the first clock;
demultiplex an Optical channel Data Tributary Unit (ODTU) signal from the HO OPUk signal using the first clock;
demap the ODTU signal to a lower order (LO) ODUj signal, wherein the LO ODUj data is smoothed using a smoothing function, wherein the first clock runs at or faster than an OTUk clock.

12. The device of claim 11, wherein the first clock is the OTUk clock.

13. The device of claim 11, wherein the first clock is a clock that runs faster than the OTUk clock.

14. The device of claim 11, wherein the smoothing function uses the first clock to increment a round-robin counter with a value between 1 and an integer P.

15. The device of claim 14, wherein P is the number of bytes per HO OTUk multi-frame.

16. The device of claim 11, wherein when
Cm is the number of LO ODUj n-byte data entities per HO OTUk multi-frame;
n is the number of bytes per LO ODUj n-byte data entity;
P is the number of bytes per HO OTUk multi-frame; and
J is a round-robin counter incremented from 1 to P at the first clock;
the smoothing function is defined by the expression “(J*Cm*n)mod P<Cm*n”, such that the smoothed data is valid if and only if the expression is true.

17. The device of claim 16, wherein the smoothing function is implemented using an accumulated value that is compared to P.

18. The device of claim 17, wherein the smoothing function is implemented using the accumulated value which is incremented in steps of Cm*n until it becomes greater than P at which point the accumulated value is subtracted by P.

19. The device of claim 16, wherein for a Generic Mapping Procedure (GMP) LO ODUj, demultiplexing from HO OPUk, the Cm value, which represents the number of LO ODUj n-byte data entities for the next HO OTUk multi-frame, can be derived from the JC bytes in the HO OPUk Overhead.

20. The device of claim 16, wherein for an Asynchronous Mapping Procedure (AMP) LO ODUj demultiplexing from HO OPUk, the Cm is calculated based on the nominal LO ODUj byte count inside per HO OTUk multi-frame plus the number of negative justifications or minus the number of positive justifications.
